(19) United States
(12) Patent Application Publication
(10) Pub. No.: US 2024/0413294 A1
(43) Pub. Date: Dec. 12, 2024

(54) CATHODE FOR ALL-SOLID-STATE BATTERIES INCLUDING NETWORK AND METHOD OF MANUFACTURING THE SAME

(71) Applicants: Hyundai Motor Company, Seoul (KR); Kia Corporation, Seoul (KR)

(72) Inventors: Yong Guk Gwon, Suwon (KR); Min Sun Kim, Goyang (KR); Yong Seok Choi, Suwon (KR); Young Jin Nam, Seoul (KR)

(21) Appl. No.: 18/237,248

(22) Filed: Aug. 23, 2023

(30) Foreign Application Priority Data
Jun. 9, 2023 (KR) 10-2023-0074315

(51) Int. Cl. H01M 4/04; H01M 4/36; H01M 4/62

(52) U.S. Cl. CPC H01M 4/0435; H01M 4/366; H01M 4/623; H01M 2004/021

(57) ABSTRACT

Disclosed are a cathode for all-solid-state batteries including a network, and a method of manufacturing the same.

### CROSS-REFERENCE TO RELATED APPLICATION

This application claims under 35 U.S.C. § 119(a) the benefit of priority to Korean Patent Application No. 10-2023-0074315 filed on Jun. 9, 2023, the entire contents of which are incorporated herein by reference.

### TECHNICAL FIELD

The present disclosure relates to a cathode for all-solid-state batteries including a network, and a method of manufacturing the same.

### BACKGROUND

In general, electrodes of lithium secondary batteries have been manufactured by a wet method in which slurry including an active material is applied to a current collector or the like and is then dried.

Recently, electrodes of lithium secondary batteries tend to be thickened in order to increase the energy density of the lithium secondary batteries, but it is difficult to thicken the electrodes using the above wet method. When the wet method is used, it is difficult to dry an electrode as the electrode becomes thicker, and an excessive amount of a binder is deposited on the surface of the electrode.

In order to solve these problems, many attempts to manufacture electrodes using a dry method are being made. In the conventional dry method, an electrode may maintain the form of a membrane by fibrillizing a suitable binder by applying shear stress to powder including an active material, the binder, or the like. However, in the above-described method, the shear stress is not sufficient nor uniformly transmitted, and thus, the surface of the electrode may be wrinkled. A battery in the unit of a pressed cell, which is less influenced by surface wrinkles and surface roughness of the electrode, may be properly operated, but a battery in the unit of a pouch cell, which is heavily influenced by surface wrinkles and surface roughness of the electrode, may not be properly operated.

The above information disclosed in this Background section is only for enhancement of understanding of the background of the invention and therefore it may contain information that does not form the prior art that is already known in this country to a person of ordinary skill in the art.

### SUMMARY

In preferred aspects, the disclosure provides a cathode for all-solid-state batteries which has no surface wrinkles and low surface roughness, and a method of manufacturing the same.

A term “all-solid-state battery” as used herein refers to a rechargeable secondary battery that includes an electrolyte in a solid state for transferring ions between the electrodes of the battery.

In one aspect, provided is a cathode for all-solid-state batteries, which includes: a first layer including a plurality of fibrous carbon materials and a first active material, and a second layer located on at least one surface of the first layer and including a second active material. Particular, the plurality of fibrous carbon materials form a network including pores such that the first active material is disposed in pores of the network.

The fibrous carbon materials may include carbon nanotubes, vapor grown carbon fibers, carbon nanofibers, or combinations thereof.

A thickness of the network may be about 5 μm to 40 μm.

A BET specific surface area of the network may be about 100 m²/g to 750 m²/g.

A total pore volume of the network may be about 0.5 cm³/g to 5 cm³/g.

A tensile strength of the network may be about 2.5 MPa to 50 MPa.

An electron conductivity of the network may be equal to or greater than about 1×10⁸ S/m.

The first active material may include a first cathode active material, a first solid electrolyte, and a first binder, and the second active material may include a second cathode active material, a second solid electrolyte, and a second binder.

The term “binder”, as used herein, refers to a resin or a polymeric material (e.g., synthetic or natural) that can be polymerized or cured to form a polymeric matrix. Preferably, the binder according to the present invention may include polytetrafluoroethylene in its composition.

The first binder may include fibrillized polytetrafluoroethylene (PTFE).

The second binder may include fibrillized polytetrafluoroethylene (PTFE).

In another aspect, the present disclosure provides a method of manufacturing a cathode for all-solid-state batteries. The method includes steps of: preparing a starting material including a cathode active material, a solid electrolyte, and a fibrous binder; supplying a plurality of fibrous carbon materials to a space between a pair of rollers rotated in opposite directions and providing the starting material to the plurality of fibrous carbon materials, and obtaining the cathode by performing film formation using the pair of rollers.

The starting material may be prepared by preparing admixture including the cathode active material, the solid electrolyte, and a particulate binder, and fibrillizing the particulate binder into the fibrous binder by applying shear stress to the mixture.

The fibrous binder may include fibrillized polytetrafluoroethylene (PTFE).

Also, the disclosure provides an all-solid-state battery including the cathode as described herein.

Further, provided is a vehicle including the all-solid-state battery as described herein.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows an exemplary cathode according to an e exemplary embodiment of the present disclosure;

FIG. 3 shows one example of calendaring equipment;

FIG. 4 shows Field Emission Scanning Electron Microscope (FE-SEM) images showing observation results of the surface of a cathode according to Comparative Example;

FIG. 5A and FIG. 5B show FE-SEM images showing observation results of parts of the surface of the cathode according to Comparative Example other than parts shown in FIG. 4;

FIG. 6 shows load-displacement curves of cathodes according to Example and Comparative Example;

FIG. 7 shows results of a load test on the cathodes according to Example and Comparative Example;

FIG. 8 shows charge capacities of all-solid-state batteries including the cathodes according to Example and Comparative Example;

FIG. 9 shows retention capacities of the all-solid-state batteries including the cathodes according to Example and Comparative Example; and

FIG. 10 shows Coulombic efficiencies of the all-solid-state batteries including the cathodes according to Example and Comparative Example.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same.

In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

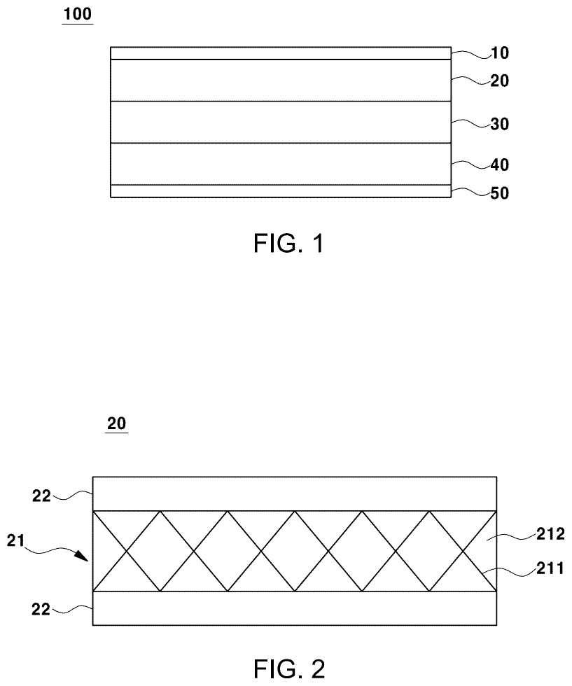

FIG. 1 shows an all-solid-state battery 100 according to an exemplary embodiment of the present disclosure. The all-solid-state battery 100 may include a cathode current collector 10, a cathode 20, a solid electrolyte layer 30, an anode 40, and anode current collector 50.

### Cathode Current Collector

The cathode current collector 10 may include a plate-shaped base material having electrical conductivity. The cathode current collector 10 may suitably include aluminum foil.

The thickness of the cathode current collector 10 is not limited to a specific value, and may be, for example, about 1 μm to 500 μm.

### Cathode

FIG. 2 shows an exemplary cathode 20 according to an exemplary embodiment of the present disclosure. The cathode 20 may include a first layer 21 including a network 211 formed by a plurality of fibrous carbon materials that is placed or disposed to intersect each other, and a first active material 212 disposed in pores in the network 211, and a second layer 22 located on at least one surface of the first layer 21 and including a second active material.

The network 211 may be suitably formed as the plurality of fibrous carbon materials is disposed to intersect each other.

The cathode 20 may be manufactured using a dry method. For example, a method of manufacturing the cathode 20 may include preparing a starting material including a cathode active material, a solid electrolyte, and a fibrous binder, supplying the network 211 to a space between a pair of rollers rotated in opposite directions and providing the starting material to at least one surface of the network 211, and acquiring the cathode 20 by performing film formation using the pair of rollers.

The present disclosure is characterized in that formation of wrinkles on the surface of the cathode 20 due to non-uniform shear stress may be prevented by supplying the network 211 as a kind of buffer layer during a film formation process in contrast to the conventional dry method.

Preparing the starting material may include preparing an admixture including the cathode active material, the solid electrolyte, and a particulate binder, and fibrillizing the particulate binder into the fibrous binder by applying shear stress to the mixture.

The mixture may further include a dispersant, a conductive material, and the like.

The particulate binder may suitably include polytetrafluoroethylene (PTFE) having a particle shape, such as a spherical or oval shape.

Polytetrafluoroethylene (PTFE) is a polymer acquired by replacing hydrogen atoms of polyethylene (PE) with fluorine atoms. Polytetrafluoroethylene (PTFE) has an aliphatic main chain but has excellent thermal stability and electrical stability, thus being widely applied to the field of electronic materials. Particularly, polytetrafluoroethylene (PTFE) has a low highest occupied molecular orbital (HOMO) level and thus has high oxidation stability, thus being mainly used in cathodes. Polytetrafluoroethylene (PTFE) has a cylindrical structure, and may thus be fibrillized at a low temperature even though it has a high glass transition temperature Tg.

Polytetrafluoroethylene (PTFE) may have specific gravity of about 2.185 or less. The lower limit of the specific gravity of polytetrafluoroethylene (PTFE) is not limited to a specific value, and may be, for example, equal to or greater than about 2. The specific gravity is used to measure the relative molecular mass of polytetrafluoroethylene (PTFE). The specific gravity may be determined based on the procedure described in ASTM D4895. A specimen to be tested may pass through a sintering and cooling cycle based on a proper sintering procedure described in ASTM D4895. The specific gravity of polytetrafluoroethylene (PTFE) is inversely proportional to the molecular weight thereof. When the specific gravity of polytetrafluoroethylene (PTFE) is equal to or less than about 2.185, the molecular weight of polytetrafluoroethylene (PTFE) is sufficiently high, and thus, fibrillization may occur well.

The particulate binder may be in a powder state having an average particle size D50 of about 1 μm to 1,000 μm.

The admixture may include an amount of about 5 wt % or less of the particulate binder based on the total weight of the admixture. When the content of the particulate binder is greater than about 5 wt %, the internal resistance of the all-solid-state battery 100 may be increased. The lower limit of the particulate binder is not limited to a specific value, and may be equal to or greater than about 0.1 wt %.

The starting material including the cathode active material, the solid electrolyte, and the fibrous binder may be acquired by fibrillizing the particulate binder into the fibrous binder by applying shear stress to the admixture.

Application of shear stress to the admixture is not limited to a specific method. Shear stress may be applied using apparatuses or methods which are generally used in the technical field to which the present disclosure pertains. For example, a Taylor-Couette reactor may be used. The mixture may be put into an outer cylinder having a cylindrical shape of the Taylor-Couette reactor, and an inner cylinder may be rapidly rotated to apply shear stress to the mixture. Further, a shear stress device having shearing and pressing abilities, such as Micros (Nara Machinery Co., Ltd.) or a Mechano Fusion System (Hosokawa Micron Corporation).

Time and temperature required for application of shear stress may be properly adjusted depending on the properties of the particulate binder, the content of the particulate binder, the specifications of equipment, and the like. For example, shear stress may be applied to the admixture at a temperature of about 100° C. to 150° C. for about 1 minute to 1 hour.

The fibrous binder may include fibrillized polytetrafluoroethylene (PTFE). The fibrous binder may have a diameter of about 0.01 μm to 10 μm. The diameter indicates the diameter of a cross section of the fibrous binder. The cross section indicates a cross section of the fibrous binder cut in a direction perpendicular to the length direction of the fibrous binder. When the diameter is less than about 0.01 μm, the mechanical properties of the cathode 20 may not be sufficient, and, when the diameter is greater than about 10 μm, the lithium ion conductivity and the electron conductivity of the cathode 20 may be reduced.

The starting material acquired by applying shear stress to the mixture may be in a clay state due to the fibrous binder. In this state, it may be difficult to supply the starting material to a subsequent process. Therefore, preparing the starting material may further include acquiring a starting material in a powder state by crushing the starting material in the clay state.

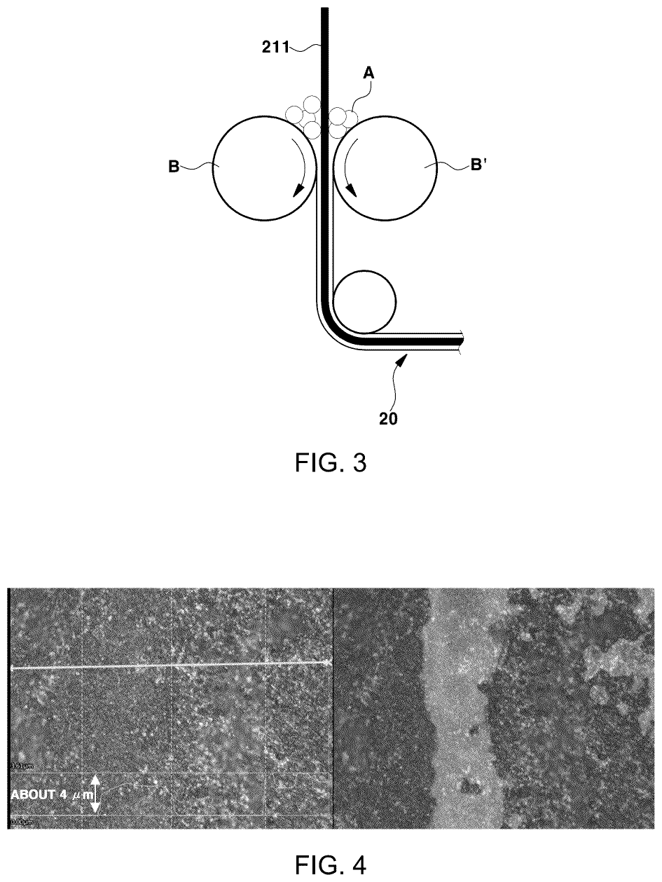

The cathode 20 may be acquired by performing film formation using the prepared starting material through a calendaring process. FIG. 3 shows an exemplary calendaring equipment.

First, the network 211 may be supplied to a space between the pair of rollers B and B′ rotated in opposite directions, and the starting material A may be provided to at least one surface of the network 211.

The network 211 may be suitably formed by the plurality of fibrous carbon materials which are placed or disposed to intersect each other. The network 211 may be porous, and may thus include the pores which are spaces between the plurality of fibrous carbon materials.

The fibrous carbon materials may include carbon nanotubes, vapor grown carbon fibers, carbon nanofibers, or combinations thereof.

The thickness of the network 211 may be about 5 μm to 40 μm. When the thickness of the network 211 is less than 5 μm, an effect of raising durability of the cathode 20 may not be obtained. When the thickness of the network 211 is greater than about 40 μm, the network 211 may be exposed from the surface of the cathode 20.

The BET specific surface area of the network 211 may be about 100 m²/g to 750 m²/g. The total pore volume of the network 211 may be about 0.5 cm³/g to 5 cm³/g. The BET specific surface area of the network 211 was measured by nitrogen adsorption at 77K using AUTOSORB-1 (manufactured by Quanta Chrome Instruments). A specimen was degassed under dynamic vacuum at 423K for 6 hours before measurement, and was then used. The BET specific surface area was calculated by the Brunauer-Emmett-Teller (BET) method. The total pore volume was estimated from the amount of adsorbed nitrogen (N₂) at about P/P₀=0.99. When the BET specific surface area and/or the total pore volume of the network 211 is less than the above-described corresponding numerical range, the tensile strength of the network 211 is reduced, and thus, the network 211 may be torn during the film formation process or it may be difficult to acquire the uniform cathode 20. When the BET specific surface area and/or the total pore volume of the network 211 is greater than the corresponding numerical range, the tensile strength of the network 211 may become excessively high, and thus, the film formation process may not be properly performed.

When the BET specific surface area and/or the total pore volume of the network 211 is within the above-described corresponding numerical range, the tensile strength of the network 211 may be about 2.5 MPa to 50 MPa.

The electron conductivity of the network 211 may be equal to or greater than about 1×10⁶ S/m or about 1×10⁸ S/m. When the electron conductivity of the network 211 is less than 1×10⁶ S/m, the electron conductivity of the cathode 20 may not be improved. The upper limit of the electron conductivity is not limited to a specific value.

Provision of the starting material A to the network 211 is not limited to a specific method. For example, the starting material A may be put into a hopper and may fall so as to be provided to at least one surface of the network 211.

The cathode 20 may be manufactured by operating the pair of rollers B and B′ spaced apart from each other by about 0.1 mm to 0.5 mm at a temperature of about 50° C. to 150° C. and the same roll rotating speed.

A part of the starting material A may be disposed in the pores of the network 211 and a remainder of the starting material A may form a layer on at least one surface of the network 211 by the pair of rollers B and B′. This will be described later.

Shear stress may be applied to the starting material A by the pair of rollers B and B′ and, in this process, the fibrous binder may be further fibrillized to increase durability of the cathode 20.

In contrast to the conventional dry method, shear stress is uniformly applied to the starting material A by the pair of rollers B and B′ by providing the network 211, and thereby, formation of wrinkles on the surface of the cathode 20 or increase in surface roughness of the cathode 20 may be prevented.

The cathode 20 manufactured by the above method may include the first layer 21 including the network 211 and the first active material 212 disposed in the pores in the network 211, and the second layer 22 located on at least one surface of the first layer 21 and including the second active material.

The first active material 212 and the second active material may be derived from the starting material A.

The first active material 212 may include a first cathode active material, a first solid electrolyte, and a first binder.

The second active material may include a second cathode active material, a second solid electrolyte, and a second binder.

Each of the first cathode active material and the second cathode active material may include a rock salt layer-type active material, such as LiCoO₂, LiMnO₂, LiNiO₂, LiVO₂ or Liᵢ₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), lithium titanate, such as Li₄Ti₅O₁₂, or the like.

Each of the first solid electrolyte and the second solid electrolyte may include an oxide-based solid electrolyte, a sulfide-based solid electrolyte, or the like.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like.

The first binder and the second binder may include the above-described fibrillized polytetrafluoroethylene (PTFE).

### Solid Electrolyte Layer

The solid electrolyte layer 30 may be interposed between the cathode 20 and the anode 40, and may include a solid electrolyte having lithium ion conductivity.

The solid electrolyte may include an oxide-based solid electrolyte, a sulfide-based solid electrolyte, or the like.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like.

### Anode

An anode 40 according to an exemplary embodiment may be a composite anode including an anode active material and a solid electrolyte.

The anode active material may include a carbon-based active material, a silicon-based active material, or a combination thereof. Particularly, the anode active material may include a combination of a carbon-based active material and a silicon-based active material, and for example, may be formed by coating cores including the carbon-based active material with shells including the silicon-based active material.

The carbon-based active material may include natural graphite, artificial graphite, or the like.

The silicon-based active material may include Si, SiOₓ (0<x<2), or the like.

The average particle size D50 of the anode active material may not be limited to a specific value, and may be, for example, about 8 μm to 10 μm.

The solid electrolyte may include an oxide-based solid electrolyte, a sulfide-based solid electrolyte, or the like.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like.

An anode 40 according to an exemplary embodiment may include lithium metal or a lithium metal alloy.

The lithium metal alloy may include an alloy of lithium and a metal or a metalloid which is capable of alloying with lithium. The metal or the metalloid which is capable of alloying with lithium may include Si, Sn, Al, Ge, Pb, Bi, Sb, or the like.

An anode 40 according to an exemplary embodiment may not include an anode active material and a component which has substantially the same function as the anode active layer. When the all-solid-state battery is charged, lithium ions migrated from the cathode 20 may be deposited and stored in the form of lithium metal between the anode 40 and the anode current collector 50.

The anode 40 may include amorphous carbon and a metal which is capable of alloying with lithium.

The amorphous carbon may include at least one selected from the group consisting of furnace black, acetylene black, Ketjen black, graphene, and combinations thereof.

The metal may include one or more selected from the group consisting of gold (Au), platinum (Pt), palladium (Pd), silicon (Si), silver (Ag), aluminum (Al), bismuth (Bi), tin (Sn), and zinc (Zn).

### Anode Current Collector

The anode current collector 50 may include a material which does not react with lithium. Concretely, the anode current collector 50 may include at least one selected from the group consisting of nickel (Ni), copper (Cu), stainless steel, and combinations thereof.

The thickness of the anode current collector 50 is not limited to a specific value, and may be, for example, about 1 μm to 500 μm.

### Example

Hereinafter, the present disclosure will be described in more detail through the following examples. The following examples serve merely to exemplarily describe the present disclosure, and are not intended to limit the scope of the invention.

### Example

A mixture was acquired by mixing a cathode active material, a sulfide-based solid electrolyte, and polytetrafluoroethylene (PTFE) in a particle state using mixing equipment.

Polytetrafluoroethylene (PTFE) in the particle state was fibrillized by placing the mixture in a mortar and applying shear stress to the mixture using a pestle. Here, shear stress is applied to the mixture at a temperature of about 120° C. for about 30 minutes.

A starting material in a powder state was acquired by crushing a starting material in a clay state acquired through the above-described process.

A cathode was manufactured by performing film formation using the calendaring equipment shown in FIG. 3. For example, a carbon nanotube sheet serving as a network was supplied to a space between a pair of rollers spaced apart from each other by about 0.1 mm and rotated at the same speed and a temperature of about 80° C., and the starting material in the powder state was provided to both surfaces of the network. Thereafter, the cathode discharged from the pair of rollers was collected.

### Comparative Example

A cathode was manufactured using the same raw materials in the same manner as in Example, except that no network is supplied to the space between the pair of rollers.

FIG. 4 shows Field Emission Scanning Electron Microscope (FE-SEM) images showing observation results of the surface of the cathode according to Comparative Example. The left image shows a surface height difference depending on position based on lines. There was a surface height difference of about 4 μm. The right image shows a surface height difference through colors. In the same manner, there was a surface height difference.

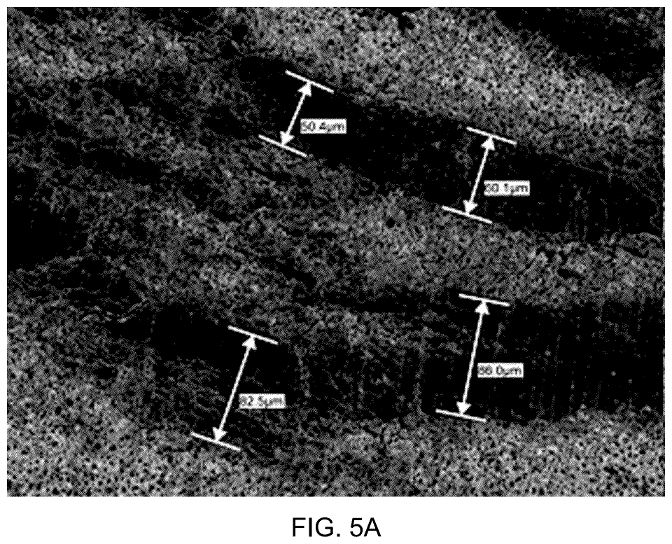

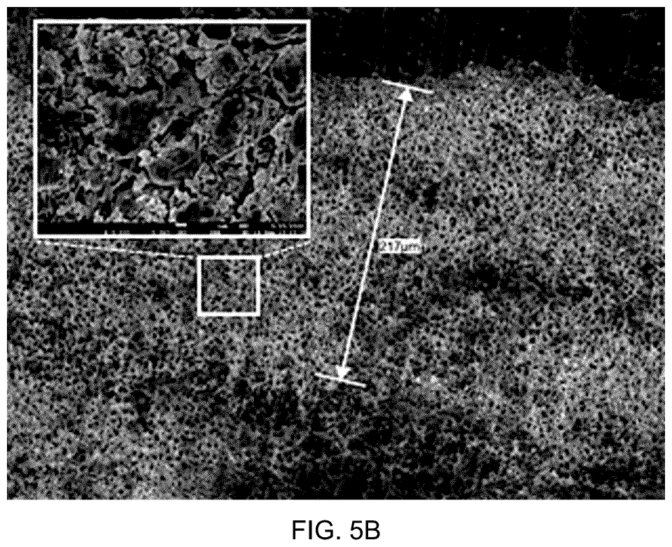

FIG. 5A and FIG. 5B show FE-SEM images showing observation results of parts of the surface of the cathode according to Comparative Example other than parts shown in FIG. 4. Wrinkles having a designated width of about 30 μm to 60 μm and repeatedly formed on the surface of the cathode are observed.

Thereby, without the network according to an exemplary embodiment of the present disclosure, the surface of a cathode was wrinkled and the surface roughness of the cathode was increased.

### Test Example 1

Adhesive strengths of the cathodes according to Example and Comparative Example were evaluated. The adhesive strengths were measured using a tensile strength testing machine (manufactured by DAESUNG precision Co., Ltd.) by the following method.

Each cathode was adhered to a slide glass using a double-sided adhesive tape. Each cathode was cut so that the width thereof fits the width of the slide glass, but the length thereof is greater than the length of the slide glass. A part of the cathode adhered to the double-sided adhesive tape and the other part of the cathode not adhered to the double-sided adhesive tape were fixed to load cells of the tensile strength testing machine, respectively. A load value depending on displacement was measured by applying tensile strength to the cathode, and a stress value was calculated based on the load value. The stress value was referred to as adhesive strength.

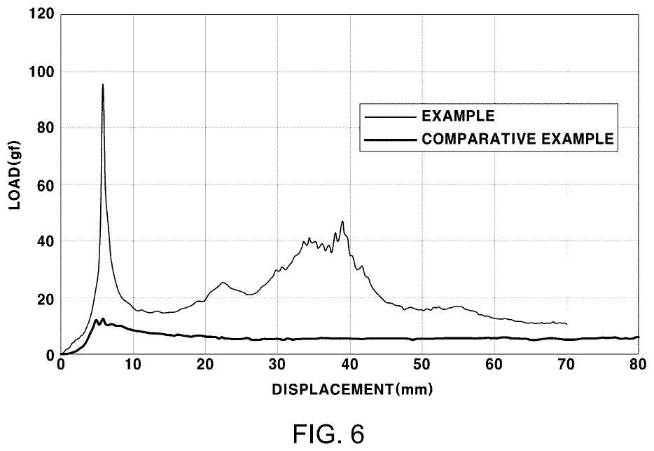

FIG. 6 shows load-displacement curves of the cathodes according to Example and Comparative Example. The cathode according to Example had excellent adhesive strength compared to the cathode according to Comparative Example. The reason for this is that the cathode according to Example had excellent mechanical properties due to good film formation, and had low surface roughness.

### Test Example 2

A load test on the cathodes according to Example and Comparative Example was performed. The load test was performed using a 2 roll-type rolling mill (manufactured by Intech Systems) by the following method.

In the film formation process using the network and the mixture in the powder state, ΔGap and a pressure automatically applied between two calendars in the load test equipment simultaneously with film formation were measured and recorded.

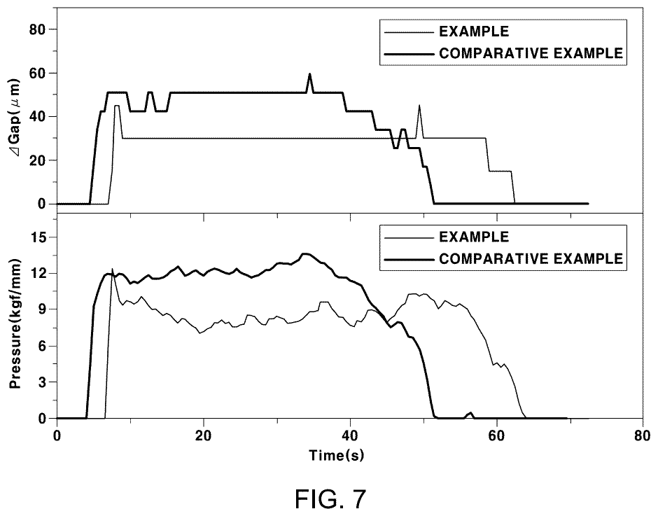

FIG. 7 shows results of the load test on the cathodes according to Example and Comparative Example. The cathode according to Example had low and uniform ΔGap compared to the cathode according to Comparative Example. The reason for this was that a pressure applied to the load test equipment to test the cathode according to Example was less than a pressure applied to the load test equipment to test the cathode according to Comparative Example. These results mean that the cathode according to Example had excellent mechanical properties due to good film formation, and had low surface roughness.

### Test Example 3

Cell performances of all-solid-state batteries including the cathodes according to Example and Comparative Example were evaluated. Charge capacities, retention capacities, and Coulombic efficiencies of the respective all-solid-state batteries were measured while charging and discharging the respective all-solid-state batteries at a temperature of 30° C. and 0.05 C (CC-CV).

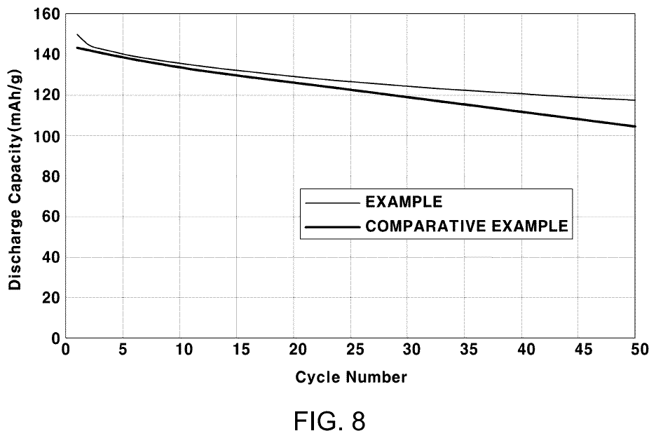

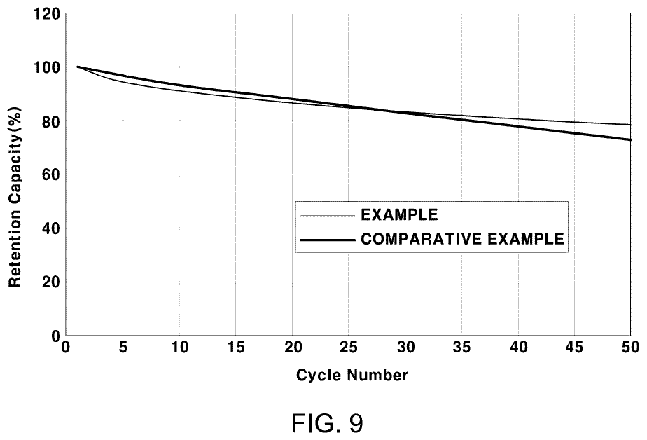

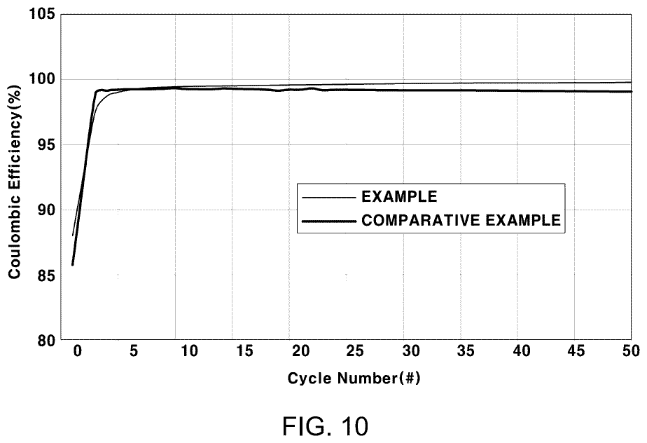

FIG. 8 shows the charge capacities of the all-solid-state batteries including the cathodes according to Example and Comparative Example. FIG. 9 shows the retention capacities of the all-solid-state batteries including the cathodes according to Example and Comparative Example. FIG. 10 shows the Coulombic efficiencies of the all-solid-state batteries including the cathodes according to Example and Comparative Example.

Thus, the cathode according to Example could further increase the charge capacity, the retention capacity, and the Coulombic efficiency of the all-solid-state battery compared to the cathode according to Comparative Example.

### Test Example 4

Electron conductivities and lithium ion conductivities of the cathodes according to Example and Comparative Example were measured.

The electron conductivities and lithium ion conductivities of the cathodes were obtained by measuring impedance values of the cathodes by applying AC voltage of 10 mV to the respective cathodes and then performing frequency sweep at 1×10⁶ to 100 Hz. Results of measurement are set forth in Table 1 below.

TABLE 1

| | Lithium ion conductivity | Electron conductivity @30° C. |
|---|---|---|
| Category | @30° C. [mS/cm] | [mS/cm] |
| Example | 0.17 | 5.32 |
| Comparative | 0.16 | 1.09 |
| example | | |

as shown in Table 1, application of the network had no negative effect on lithium ion conductivity of the cathode. Further, the cathode according to Example exhibited remarkably greater electron conductivity than the cathode according to Comparative Example.

As is apparent from the above description, according to various exemplary embodiments of the present disclosure, a cathode for all-solid-state batteries which has no surface wrinkles and low surface roughness, and a method of manufacturing the same can be provided.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A cathode for all-solid-state batteries, comprising:
a first layer comprising a plurality of fibrous carbon materials and a first active material; and
a second layer located on at least one surface of the first layer and comprising a second active material, and
wherein the plurality of fibrous carbon materials forms a network comprising pores and the first active material is disposed in pores of the network.

2. The cathode of claim 1, wherein the fibrous carbon materials comprise carbon nanotubes, vapor grown carbon fibers, carbon nanofibers, or combinations thereof.

3. The cathode of claim 1, wherein a thickness of the network is about 5 μm to 40 μm.

4. The cathode of claim 1, wherein a BET specific surface area of the network is about 100 m²/g to 750 m²/g.

5. The cathode of claim 1, wherein a total pore volume of the network is about 0.5 cm³/g to 5 cm³/g.

6. The cathode of claim 1, wherein tensile strength of the network is about 2.5 MPa to 50 MPa.

7. The cathode of claim 1, wherein electron conductivity of the network is equal to or greater than about 1×10⁸ S/m.

8. The cathode of claim 1, wherein:
the first active material comprises a first cathode active material, a first solid electrolyte, and a first binder; and
the second active material comprises a second cathode active material, a second solid electrolyte, and a second binder.

9. The cathode of claim 8, wherein the first binder comprises fibrillized polytetrafluoroethylene (PTFE).

10. The cathode of claim 8, wherein the second binder comprises fibrillized polytetrafluoroethylene (PTFE).

11. A method of manufacturing a cathode for all-solid-state batteries, comprising:
preparing a starting material comprising a cathode active material, a solid electrolyte, and a fibrous binder;
supplying a plurality of fibrous carbon materials to a space between a pair of rollers rotated in opposite directions and providing the starting material to the plurality of fibrous carbon materials; and
obtaining the cathode by performing film formation using the pair of rollers,
wherein the cathode comprises:
a first layer comprising the plurality of fibrous carbon materials and a first active material wherein the plurality of fibrous carbon materials forms a network comprising pores and the first active material is disposed in the pores of the network; and
a second layer located on at least one surface of the first layer and comprising a second active material.

12. The method of claim 11, wherein preparing the starting material comprises:
preparing an admixture comprising the cathode active material, the solid electrolyte, and a particulate binder; and
fibrillizing the particulate binder into the fibrous binder by applying shear stress to the mixture.

13. The method of claim 11, wherein the fibrous binder comprises fibrillized polytetrafluoroethylene (PTFE).

14. The method of claim 11, wherein the fibrous carbon materials comprise carbon nanotubes, vapor grown carbon fibers, carbon nanofibers, or combinations thereof.

15. The method of claim 11, wherein a thickness of the network is about 5 μm to 40 μm.

16. The method of claim 11, wherein a BET specific surface area of the network is about 100 m²/g to 750 m²/g.

17. The method of claim 11, wherein a total pore volume of the network is about 0.5 cm³/g to 5 cm³/g.

18. The method of claim 11, wherein tensile strength of the network is about 2.5 MPa to 50 MPa.

19. The method of claim 11, wherein electron conductivity of the network is equal to or greater than about 1×10⁸ S/m.

20. An all-solid-state battery comprising a cathode of claim 1.
